(19) United States
(12) Patent Application Publication
(10) Pub. No.: US 2026/0192776 A1
(43) Pub. Date: Jul. 9, 2026

(54) VEHICLE DOOR CONTROL APPARATUS, METHOD, AND COMPUTER-READABLE MEDIUM

(71) Applicant: NEC Corporation, Tokyo (JP)

(72) Inventors: Kazuki INAGAKI, Tokyo (JP); Yuta SHIMIZU, Tokyo (JP)

(73) Assignee: NEC Corporation, Tokyo (JP)

(21) Appl. No.: 19/133,003

(22) PCT Filed: Dec. 12, 2022
(86) PCT No.: PCT/JP2022/045630

§ 371 Date: May 27, 2025

(51) Int. Cl. B60R 25/20; G06F 3/01

(52) U.S. Cl. CPC B60R 25/20; G06F 3/013

(57) ABSTRACT

A line-of-sight detection means detects the line of sight of the user based on an image obtained by capturing the user. A determination means determines whether or not the user has looked at a region corresponding to a specific door for a predetermined time or more based on the detected line of sight of the user. An authentication means authenticates the user using the image obtained by capturing the user. A door control means unlocks the specific door in a case where it is determined that the user has looked at the region corresponding to the specific door for the predetermined time or more and the user has succeeded in the authentication.

### TECHNICAL FIELD

The present disclosure relates to a vehicle door control apparatus, a method, and a computer-readable medium.

### BACKGROUND ART

As the related art, Patent Literature 1 discloses a smart entry system. In the smart entry system described in Patent Literature 1, a user carries an electronic key and approaches a vehicle. An electronic key authentication apparatus disposed inside the vehicle wirelessly communicates with the electronic key carried by the user to authenticate the electronic key. Furthermore, a camera disposed in the vehicle captures an image of the user who carries the electronic key. In the vehicle, the user directs his/her line of sight to a region corresponding to a door desired to be selected from among a plurality of regions respectively preset for doors. A computing apparatus detects the line of sight of the user from the image captured by the camera, and determines the door selected by the user based on the detected line of sight. A door unlocking apparatus unlocks the door selected by the user.

### CITATION LIST

### Patent Literature

Patent Literature 1: Japanese Unexamined Patent Application Publication No. 2008-2095

### SUMMARY OF INVENTION

### Technical Problem

In Patent Literature 1, the door unlocking apparatus unlocks the door corresponding to the region to which the user directs the line of sight. The user can direct the line of sight to any region to select a desired door. However, the line of sight may fluctuate while the user is walking, and there is a possibility that the user cannot accurately specify the door desired to be opened.

In view of the above circumstances, an object of the present disclosure is to provide a vehicle door control apparatus, a method, and a computer-readable medium which can accurately control a door desired to be controlled by a user based on a line of sight of the user.

### Solution to Problem

To achieve the above object, the present disclosure provides a vehicle door control apparatus as a first aspect. The vehicle door control apparatus includes: a line-of-sight detection means for detecting a line of sight of a user based on an image obtained by capturing the user who intends to ride in a vehicle including a plurality of doors; a determination means for determining, based on the detected line of sight, whether or not the user has looked at a region corresponding to a specific door for a predetermined time or more; an authentication means for authenticating the user using the image; and a door control means for unlocking the specific door in a case where it is determined that the user has looked at the region corresponding to the specific door for the predetermined time or more and the user has succeeded in the authentication.

The present disclosure provides a vehicle door control method as a second aspect. A vehicle door providing method includes: detecting a line of sight of a user based on an image obtained by capturing the user who intends to ride in a vehicle including a plurality of doors; determining, based on the detected line of sight, whether or not the user has looked at a region corresponding to a specific door for a predetermined time or more; authenticating the user using the image; and unlocking the specific door in a case where it is determined that the user has looked at the region corresponding to the specific door for the predetermined time or more and the user has succeeded in the authentication.

The present disclosure provides a computer-readable medium as a third aspect. The computer-readable medium stores a program for causing a processor to execute processing including: detecting a line of sight of a user based on an image obtained by capturing the user who intends to ride in a vehicle including a plurality of doors; determining, based on the detected line of sight, whether or not the user has looked at a region corresponding to a specific door for a predetermined time or more; authenticating the user using the image; and unlocking the specific door in a case where it is determined that the user has looked at the region corresponding to the specific door for the predetermined time or more and the user has succeeded in the authentication.

### Advantageous Effects of Invention

The vehicle door control apparatus, the method, and the computer-readable medium according to the present disclosure can accurately control the door desired to be controlled by the user based on the line of sight of the user.

### BRIEF DESCRIPTION OF DRAWINGS

FIG. 1 is a block diagram illustrating a schematic configuration example of a vehicle door control apparatus according to the present disclosure.

FIG. 2 is a block diagram illustrating a vehicle door control apparatus according to a first example embodiment of the present disclosure.

FIG. 3 is a schematic diagram illustrating a vehicle and a region to which a line of sight of a user is directed.

FIG. 4 is a flowchart illustrating an operation procedure of a vehicle control door apparatus.

FIG. 5 is a block diagram illustrating a vehicle control apparatus according to a second example embodiment of the present disclosure.

FIG. 6 is a block diagram illustrating a hardware configuration of the vehicle control apparatus.

### EXAMPLE EMBODIMENT

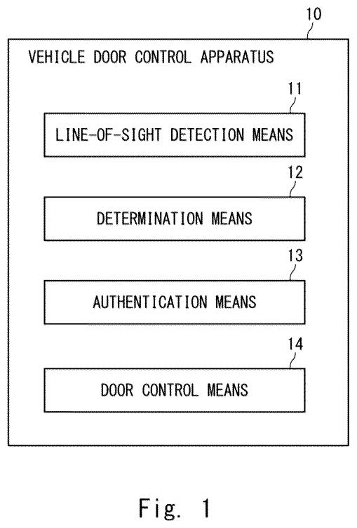

Prior to describing example embodiments of the present disclosure, an outline of the present disclosure will be described. FIG. 1 illustrates a schematic configuration example of a vehicle door control apparatus according to the present disclosure. A vehicle door control apparatus 10 includes a line-of-sight detection means 11, a determination means 12, an authentication means 13, and a door control means 14.

The line-of-sight detection means 11 detects a line of sight of a user based on an image of a person who intends to ride in a vehicle including a plurality of doors, that is, the user. The determination means 12 determines whether or not the user has looked at a region corresponding to a specific door among the plurality of doors of the vehicle for a predetermined time or more based on the line of sight detected by the line-of-sight detection means 11.

The authentication means authenticates the user using the image obtained by capturing the user who intends to ride in the vehicle. The door control means unlocks the specific door in a case where it is determined that the user has looked at the specific door for the predetermined time or more and the user has succeeded in the authentication.

In the present disclosure, the door control means 14 unlocks the specific door in a case where the user has looked at the region corresponding to the specific door for the predetermined time or more and the user has succeeded in the authentication. In the present disclosure, since the door corresponding to the region at which the user has looked for the predetermined time or more is controlled, it is possible to reduce the possibility that a door different from the door that the user desires to open is controlled. Therefore, the vehicle door control apparatus 10 according to the present disclosure can accurately control the door desired to be controlled by the user based on the line of sight of the user.

Hereinafter, the example embodiments of the present disclosure will be described in detail with reference to the drawings. Note that, in the following description and drawings, omission and simplification are made as appropriate, for clarity of description. Furthermore, the same elements and similar elements are denoted by the same reference signs throughout the drawings, and redundant description is omitted as necessary.

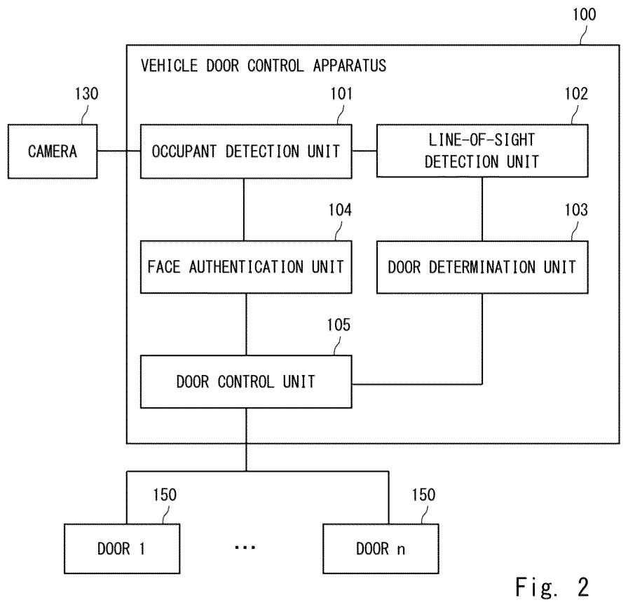

FIG. 2 illustrates a vehicle door control apparatus according to a first example embodiment of the present disclosure. A vehicle door control apparatus 100 includes an occupant detection unit 101, a line-of-sight detection unit 102, a door determination unit 103, a face authentication unit 104, and a door control unit 105. The vehicle door control apparatus 100 can be physically configured as an apparatus including, for example, one or more memories and one or more processors. At least some of functions of the units in the vehicle door control apparatus 100 may be implemented in such a way that the one or more processors operate in accordance with a command read from the one or more memories.

The vehicle door control apparatus 100 is mounted on a vehicle, for example. The vehicle door control apparatus 100 corresponds to the vehicle door control apparatus 10 illustrated in FIG. 1.

The occupant detection unit 101 acquires a camera image from a camera 130. The camera 130 is a camera that is mounted on the vehicle and captures an image of a region around the vehicle. The camera 130 captures an image of a person who intends to ride in the vehicle, that is, an occupant. The occupant of the vehicle is also referred to as a user. The camera 130 may be embedded, for example, in a B-pillar of the vehicle, that is, a pillar between a front door and a rear door.

Note that, although only one camera 130 is illustrated in FIG. 2, the number of cameras 130 is not limited to one. The occupant detection unit 101 may acquire camera images from a plurality of the cameras 130, respectively. For example, the occupant detection unit 101 may acquire camera images from a camera that captures an image of a left region of the vehicle, a camera that captures an image of a right region of the vehicle, and a camera that captures an image of a rear region of the vehicle, respectively.

The occupant detection unit 101 detects the user who intends to ride in the vehicle using the camera image. For example, the occupant detection unit 101 extracts a face image or a face region of a person near the vehicle from the camera image. If the face image or the face region is extracted, the occupant detection unit 101 determines that the user is detected. The line-of-sight detection unit 102 detects the line of sight of the user detected by the occupant detection unit 101 based on the camera image. For example, the line-of-sight detection unit 102 detects the user's eyes from the image of the face region in the camera image, that is, the face image, and detects any direction to which the user's eyes are directed. The line of sight can be detected using any known algorithm. The line-of-sight detection unit 102 corresponds to the line-of-sight detection means 11 illustrated in FIG. 1.

The vehicle includes a plurality of doors 150. Furthermore, a plurality of regions corresponding to the plurality of doors 150 are set in the vehicle. The door determination unit 103 determines whether or not the user has looked at a region corresponding to a specific door for a predetermined time or more based on the line of sight of the user detected by the line-of-sight detection unit 102. In a case where the user has looked at the region corresponding to the specific door for the predetermined time or more, the door determination unit 103 determines the specific door as a door to be controlled. In other words, the door determination unit 103 determines the door corresponding to the region to which line of sight of the user has been directed for the predetermined time or more as the door to be controlled. The door determination unit 103 corresponds to the determination means 12 illustrated in FIG. 1.

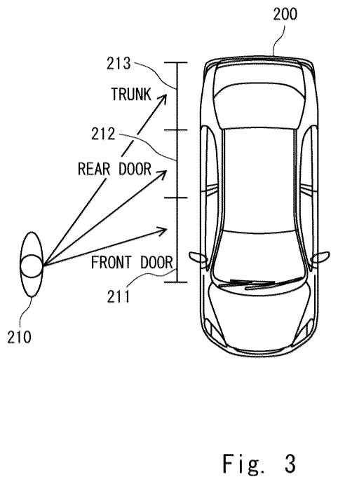

FIG. 3 schematically illustrates the vehicle and the line of sight of the user. In this example, the user is approaching a vehicle 200 from the right side of the vehicle 200. The line-of-sight detection unit 102 detects a line of sight of a user 210 based on a camera image. It is considered that, for example, the user 210 will look at a front door while approaching the vehicle 200 if he/she wants to open the front door. Furthermore, it is considered that the user 210 will look at a rear door if he/she wants to open the rear door. It is considered that the user 210 will look at a trunk or a rear hatch if he/she wants to open the trunk or the rear hatch.

In a case where the line of sight of the user 210 has been directed to a specific door for a certain time or more, the door determination unit 103 specifies that a door that the user 210 desires to open is the door in the line-of-sight direction. For example, in a case where the line of sight of the user has been directed to a region 211 corresponding to the front door for a predetermined time or more, the door determination unit 103 determines the front door as a door to be controlled. In a case where the line of sight of the user has been directed to a region 212 corresponding to the rear door for the predetermined time or more, the door determination unit 103 determines the rear door as the door to be controlled. In a case where the line of sight of the user has been directed to a region 213 corresponding to the trunk or the rear hatch for the predetermined time or more, the door determination unit 103 determines the trunk or the rear hatch as the door to be controlled.

Note that FIG. 3 illustrates an example in which the user 210 on the right side of the vehicle 200 opens a door on the right side of the vehicle, but the present example embodiment is not limited thereto. Regions respectively corresponding to the door on the right side of the vehicle and a door on the left side of the vehicle may be set on the right side of the vehicle. In this case, the door determination unit 103 may determine the door on the right side or the door on the left side as the door to be controlled depending on a region to which line of sight of the user is directed. The number of doors to be controlled is not necessarily one, and the door determination unit 103 may determine a plurality of doors as the doors to be controlled in a case where the line of sight of the user is directed to a certain region for the predetermined time or more.

The door determination unit 103 may change the predetermined time in accordance with a direction of the face of the user in the camera image. Ease of the line-of-sight detection or accuracy of the line-of-sight detection may change in accordance with the direction of the face of the user with respect to the camera 130. For example, in a case where the face of the user is greatly inclined with respect to the camera 130, it is considered that detection accuracy of the line-of-sight direction is lower as compared with a case where the face of the user faces the camera 130. The door determination unit 103 may set the predetermined time to be longer in a case where the face of the user is directed in a direction in which the detection accuracy of the line-of-sight direction is lower as compared with a case where the face of the user is directed in a direction in which the detection accuracy of the line-of-sight direction is higher.

Instead of or in addition to changing the predetermined time in accordance with the direction of the face, the door determination unit 103 may change the predetermined time in accordance with a distance between the user and the vehicle. Since an image of the user becomes smaller in the camera image as the distance increases, it is considered that the ease or accuracy of the detection of the line-of-sight direction decreases as the distance increases. In a case where the distance between the user and the vehicle is long and thus it is expected that the detection accuracy of the line-of-sight direction is low, the door determination unit 103 may set the predetermined time to be longer than that in a case where the distance is short. The distance between the user and the vehicle may be estimated from the camera image, or may be separately measured using a sensor capable of measuring the distance such as light detection and ranging (LiDAR).

In a case where the predetermined time is changed in accordance with the direction of the face and/or the distance, the predetermined time can be appropriately set in accordance with the ease or accuracy of the detection of the line-of-sight that changes in accordance with the direction of the face and the distance. Therefore, it is considered that the door determination unit 103 can more accurately determine the door to be controlled.

The face authentication unit 104 authenticates the user detected by the occupant detection unit 101. In the present example embodiment, the face authentication unit 104 authenticates the user by face authentication using a camera image of the camera 130. For example, a face image of a person who is permitted to ride in the vehicle or a feature amount extracted from the face image is registered in the face authentication unit 104. The face authentication unit 104 compares a face image included in the camera image or a feature amount extracted from the face image with the registered face image or feature amount. The face authentication unit 104 calculates a verification score indicating the degree of similarity between the face image included in the camera image or the feature amount extracted from the face image and the registered face image or feature amount. The face authentication unit 104 determines that the face authentication of the user is successful in a case where the verification score is a predetermined threshold or more. The face authentication unit 104 corresponds to the authentication means 13 illustrated in FIG. 1.

The door control unit 105 unlocks a specific door in a case where it is determined that the user has looked at a region corresponding to the specific door for the predetermined time or more and in a case where the user has succeeded in the face authentication. In other words, in a case where the face authentication of the user is successful in the face authentication unit 104, the door control unit 105 unlocks the door determined to be the door to be controlled by the door determination unit 103. The door control unit 105 corresponds to the door control means 14 illustrated in FIG. 1.

For example, in a case where the user has looked at the region corresponding to the front door for the predetermined time or more and the user has succeeded in the face authentication, the door control unit 105 unlocks the front door. The door control unit 105 may not only unlock the door but also open the door. For example, if the door is an electric sliding door, the door control unit 105 transmits a control signal to a controller such as an electronic control unit (ECU) that controls the electric sliding door, and controls a motor that drives the electric sliding door. For example, if the door is a hinge door, the door control unit 105 may bring the door into a half-closed state via some mechanism.

In the present example embodiment, in a case where the user approaches the vehicle, the door determination unit 103 may determine whether or not the user has looked at a region corresponding to a specific door for the predetermined time or more after the distance between the user and the vehicle is within a first distance. In other words, the door determination unit 103 may determine the door to be controlled in a case where the user approaches the vehicle by the first distance. Similarly, the face authentication unit 104 may authenticate the user by the face authentication after the distance between the user and the vehicle is within the first distance. The determination of the door to be controlled by the door determination unit 103 and the face authentication by the face authentication unit 104 may be performed in parallel. Further, the door control unit 105 may control the door after the distance between the user and the vehicle is within a second distance shorter than the first distance.

For example, the door determination unit 103 and the face authentication unit 104 may perform the determination on the door to be controlled and the face authentication in a case where the user approaches a distance of 5 m from the vehicle, and the door control unit 105 may control the door in a case where the user approaches a distance of 1 m from the vehicle. In this case, the determination on the door to be controlled and the face authentication can be completed before the user is close to the vehicle, and the door can be unlocked after the user sufficiently approaches the vehicle.

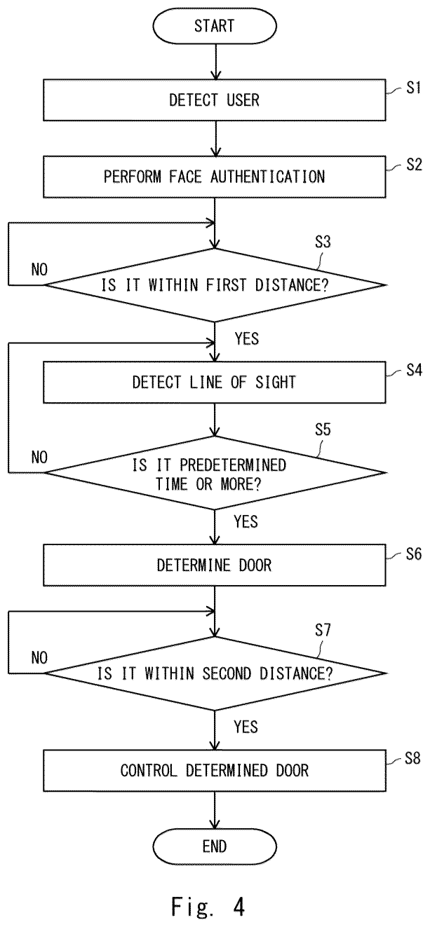

Next, an operation procedure will be described. FIG. 4 illustrates an operation procedure of the vehicle door control apparatus 100. The operation procedure of the vehicle door control apparatus 100 corresponds to a vehicle door control method. The occupant detection unit 101 detects a user around the vehicle based on a camera image of the camera 130 (step S1). The face authentication unit 104 performs face authentication on the user detected in step S1 (step S2).

The line-of-sight detection unit 102 determines whether or not a distance between the user and the vehicle is within the first distance (step S3). In a case where the line-of-sight detection unit 102 determines that the distance between the user and the vehicle is within the first distance in step S3, the line-of-sight detection unit 102 detects a line of sight of the user detected in step S1 (step S4). Any of steps S2 and S4 may be performed first, or the both may be performed in parallel. Furthermore, in a case where the face authentication has failed in step S2, the processing in and after step S3 is not necessarily performed.

The door determination unit 103 determines whether or not the line of sight of the user is directed to a region corresponding to a specific door for the predetermined time or more in the line-of-sight detection unit 102 (step S5). In a case where it is determined in step S5 that the line of sight of the user has not been directed to the region corresponding to the specific door for the predetermined time or more, the processing returns to step S4, and the line of sight of the user is detected in step S4. In a case where it is determined in step S5 that line of sight of the user has been directed to the region corresponding to the specific door for the predetermined time or more, the door determination unit 103 determines the specific door as a door to be controlled (step S6).

The door control unit 105 determines whether or not the distance between the user and the vehicle is within the second distance (step S7). In a case where the distance between the user and the vehicle is determined to be within the second distance in step S7 and the face authentication is successful in step S2, the door control unit 105 controls the door determined in step S6 (step S8). In step S8, the door control unit 105 unlocks, for example, the door determined as one to be controlled. In a case where the face authentication has failed in step S2, the door control unit 105 does not control the door.

In the present example embodiment, the line-of-sight detection unit 102 detects the line of sight of the user, and in a case where the line of sight of the user has been directed to a region corresponding to a specific door, the door determination unit 103 determines such a door as the door to be controlled. In a case where the user succeeds in the face authentication in the face authentication unit 104, the door control unit 105 unlocks the door determined as the door to be controlled by the door determination unit 103. In the present example embodiment, the door corresponding to the region at which the user has looked for the predetermined time or more is controlled. Therefore, the door determination unit 103 can correctly determine the door that the user desires to open, and the door control unit 105 can unlock the door that the user desires to open.

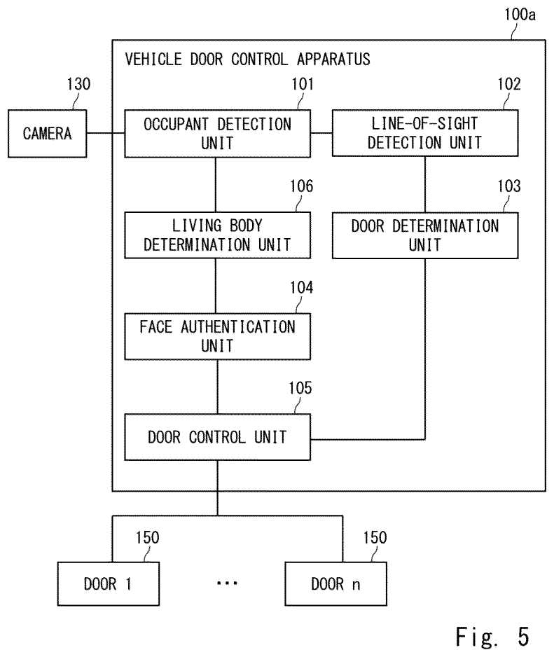

Next, a second example embodiment of the present disclosure will be described. FIG. 5 illustrates a vehicle door control apparatus according to a second example embodiment of the present disclosure. In the present example embodiment, a vehicle door control apparatus 100a includes a living body determination unit 106 in addition to the configuration of the vehicle door control apparatus 100 according to the first example embodiment illustrated in FIG. 2. In a case where a user is moving toward a vehicle, the living body determination unit 106 determines whether or not a face of the user in a camera image is a face of a living body based on the camera image of the camera 130. For example, the living body determination unit 106 determines whether the face of the user in the camera image is an artificial object such as a photograph or the user's own face. The living body determination unit 106 is also referred to as a living body determination means.

For example, in a case where the user walks toward the vehicle, it is considered that the line of sight of the user will change with a change in a distance between the user and the vehicle if the user approaches the vehicle while looking at a specific door. On the other hand, in a case where a person who does not have the authority to use the vehicle is approaching the vehicle while showing a photograph of the face of the user, it is considered that the line of sight of the user detected from the camera image is constant even if the distance changes. The living body determination unit 106 can determine whether or not the face of the user in the camera image is the face of the living body based on the change in the line-of-sight of the moving user.

For example, in a case where the user walks toward the vehicle, the living body determination unit 106 determines whether or not the line of sight detected by the line-of-sight detection unit 102 has changed with a change in the distance between the user and the vehicle. Based on a result of the determination, the living body determination unit 106 determines whether or not the face of the user is the face of the living body. In a case where the line of sight of the user changes as the user moves, the living body determination unit 106 determines that the face of the user in the camera image is the face of the living body. In a case where the line of sight of the user does not change, the living body determination unit 106 determines that the face of the user in the camera image is not the face of the living body.

Instead of or in addition to determining whether or not the face in the camera image is the face of the living body based on the change in the line of sight, the living body determination unit 106 may determine whether or not the face in the camera image is the face of the living body based on a movement of a torso and a movement of the face of the user in the camera image. For example, the living body determination unit 106 detects a vertical movement of a region of the face of the user in the camera image and a vertical movement of a region of the torso of the user in the camera image. The living body determination unit 106 determines whether or not the vertical movement of the region of the face is interlocked with the vertical movement of the region of the torso.

For example, in a case where a person approaches the vehicle while showing a photograph of the face of the user, it is considered that a region of the face as the photograph and a region of a torso as a living body, that is, a region below a neck do not move in conjunction with each other in the camera image to cause an unnatural movement. In a case where the vertical movement of the region of the face of the user in the camera image is interlocked with the vertical movement of the region of the torso of the user in the camera image, the living body determination unit 106 determines that the face in the camera image is the face of the living body. In a case where the vertical movement of the region of the face of the user in the camera image is not interlocked with the vertical movement of the region of the torso of the user in the camera image, the living body determination unit 106 determines that the face in the camera image is not the face of the living body.

In the present example embodiment, in a case where the living body determination unit 106 determines that the face of the user in the camera image is not the face of the living body, the face authentication unit 104 determines that the authentication of the user has failed. Alternatively, the face authentication unit 104 does not necessarily perform the face authentication in a case where the living body determination unit 106 determines that the face of the user in the camera image is not the face of the living body. In the present example embodiment, in a case where the living body determination unit 106 determines that the face of the user in the camera image is not the face of the living body, the face authentication is not successful in the face authentication unit 104. Therefore, the door control unit 105 does not control the door.

In the present example embodiment, the living body determination unit 106 determines whether or not the face of the user in the camera image is the face of the living body. In a case where the face is not determined to be the face of the living body in the living body determination unit 106, the face authentication of the user is not successful in the face authentication unit 104. Therefore, a malicious person can be prevented from impersonating the user using the photograph of the face of the user, and security can be improved. Other effects are similar to the effects described in the first example embodiment.

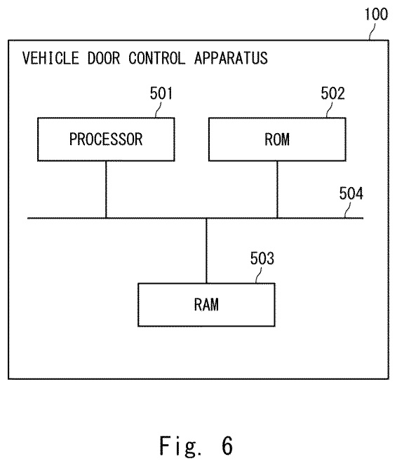

Next, a hardware configuration of the vehicle door control apparatus 100 will be described. FIG. 6 illustrates an example of the hardware configuration of the vehicle door control apparatus 100. The vehicle door control apparatus 100 includes a processor (central processing unit (CPU)) 501, a read only memory (ROM) 502, and a random access memory (RAM) 503. In the vehicle door control apparatus 100, the processor 501, the ROM 502, and the RAM 503 are interconnected via a bus 504. The vehicle door control apparatus 100 may include another circuit such as a peripheral circuit, a communication circuit, and an interface circuit, although illustration thereof is omitted.

The ROM 502 is a non-volatile storage device. For example, a semiconductor storage device such as a flash memory having a relatively small capacity is used for the ROM 502. The ROM 502 stores a program executed by the processor 501.

The program described above includes a group of commands (or software codes) for causing a computer to perform one or more functions described in the example embodiments when the program is read by the computer. The program may be stored in a non-transitory computer-readable medium or a tangible storage medium. By way of example, and not limitation, computer-readable media or tangible storage media include a RAM, a ROM, a flash memory, a solid-state drive (SSD) or other memory technologies, a compact disc (CD), a digital versatile disc (DVD), a Blu-ray (registered trademark) disc or other optical disc storages, a magnetic cassette, a magnetic tape, a magnetic disk storage or other magnetic storage devices. The program may be transmitted on a transitory computer-readable medium or a communication medium. By way of example, and not limitation, transitory computer-readable media or communication media include electrical, optical, acoustic, or other forms of propagated signals.

The RAM 503 is a volatile storage device. As the RAM 503, various types of semiconductor memory devices such as a dynamic random access memory (DRAM) or a static random access memory (SRAM) are used. The RAM 503 can be used as an internal buffer for transitorily storing data and the like.

The processor 501 develops the program stored in the ROM 502 on the RAM 503, and executes the program. The functions of the units in the vehicle door control apparatus 100 can be implemented by the CPU 501 executing the program.

Note that the vehicle door control apparatus 100 is not necessarily a single apparatus. The vehicle door control apparatus 100 may be configured using a plurality of physically separated apparatuses. Furthermore, the vehicle door control apparatus 100 does not necessarily have all the functions mounted on the vehicle. For example, at least one of the line-of-sight detection unit 102, the door determination unit 103, and the face authentication unit 104 in the vehicle door control apparatus 100 may be disposed outside the vehicle. In this case, a functional unit disposed in the vehicle and a functional unit disposed outside the vehicle may transmit and receive information via a wireless communication network.

Although the example embodiments of the present disclosure have been described above in detail, the present disclosure is not limited to the above example embodiments, and the present disclosure also includes changes or modifications made to the above example embodiments without departing from the scope of the present disclosure.

For example, some or all of the above-described example embodiments may be described as the following Supplementary Notes, but the present disclosure is not limited to the following Supplementary Notes.

### [Supplementary Note 1]

A vehicle door control apparatus including:
a line-of-sight detection means for detecting a line of sight of a user based on an image obtained by capturing the user who intends to ride in a vehicle including a plurality of doors;
a determination means for determining, based on the detected line of sight, whether or not the user has looked at a region corresponding to a specific door for a predetermined time or more;
an authentication means for authenticating the user using the image; and
a door control means for unlocking the specific door in a case where it is determined that the user has looked at the region corresponding to the specific door for the predetermined time or more and the user has succeeded in the authentication.

### [Supplementary Note 2]

The vehicle door control apparatus according to Supplementary Note 1, wherein the determination means changes the predetermined time in accordance with a direction of a face of the user in the image.

### [Supplementary Note 3]

The vehicle door control apparatus according to Supplementary Note 1 or 2, wherein the determination means changes the predetermined time in accordance with a distance between the user and the vehicle.

### [Supplementary Note 4]

The vehicle door control apparatus according to any one of Supplementary Notes 1 to 3, wherein
the determination means determines whether or not the user has looked at the region corresponding to the specific door for the predetermined time or more after a distance between the user and the vehicle is within a first distance, and
the door control means unlocks the specific door after the distance between the user and the vehicle is within a second distance shorter than the first distance.

### [Supplementary Note 5]

The vehicle door control apparatus according to any one of Supplementary Notes 1 to 4, wherein the authentication means authenticates the user by face authentication.

### [Supplementary Note 6]

The vehicle door control apparatus according to Supplementary Note 5, further including a living body determination means for determining whether or not a face of the user in the image is a face of a living body based on the image while the user is moving toward the vehicle,
wherein the authentication means fails to authenticate the user in a case where the face of the user in the image is not determined to be the face of the living body.

### [Supplementary Note 7]

The vehicle door control apparatus according to Supplementary Note 6, wherein the living body determination means determines whether or not the detected line of sight has changed with a change in a distance between the user and the vehicle, and based on a result of the determination, determines whether or not the face of the user in the image is the face of the living body.

### [Supplementary Note 8]

The vehicle door control apparatus according to Supplementary Note 6 or 7, wherein the living body determination means determines whether or not the face of the user in the image is the face of the living body based on a movement of a torso of the user in the image and a movement of the face in the image.

### [Supplementary Note 9]

The vehicle door control apparatus according to Supplementary Note 8, wherein the living body determination means determines whether or not a vertical movement of a region of the face of the user in the image is interlocked with a vertical movement of a region of the torso of the user in the image, and based on a result of the determination, determines whether or not the face of the user in the image is the face of the living body.

### [Supplementary Note 10]

A vehicle door control method including:
detecting a line of sight of a user based on an image obtained by capturing the user who intends to ride in a vehicle including a plurality of doors;
determining, based on the detected line of sight, whether or not the user has looked at a region corresponding to a specific door for a predetermined time or more;
authenticating the user using the image; and
unlocking the specific door in a case where it is determined that the user has looked at the region corresponding to the specific door for the predetermined time or more and the user has succeeded in the authentication.

### [Supplementary Note 11]

A non-transitory computer-readable medium storing a program for causing a processor to execute processing including:
detecting a line of sight of a user based on an image obtained by capturing the user who intends to ride in a vehicle including a plurality of doors;
determining, based on the detected line of sight, whether or not the user has looked at a region corresponding to a specific door for a predetermined time or more;
authenticating the user using the image; and
unlocking the specific door in a case where it is determined that the user has looked at the region corresponding to the specific door for the predetermined time or more and the user has succeeded in the authentication.

### REFERENCE SIGNS LIST

10 VEHICLE DOOR CONTROL APPARATUS
11 LINE-OF-SIGHT DETECTION MEANS
12 DETERMINATION MEANS
13 AUTHENTICATION MEANS
14 DOOR CONTROL MEANS
100 VEHICLE DOOR CONTROL APPARATUS
101 OCCUPANT DETECTION UNIT
102 LINE-OF-SIGHT DETECTION UNIT
103 DOOR DETERMINATION UNIT
104 FACE AUTHENTICATION UNIT
105 DOOR CONTROL UNIT
106 LIVING BODY DETERMINATION UNIT
130 CAMERA
150 DOOR
200 VEHICLE
210 USER
211 to 213 REGION
501 PROCESSOR
502 ROM
503 RAM
504 BUS

What is claimed is:

1. A vehicle door control apparatus comprising:
at least one memory storing instructions; and
at least one processor configured to execute the instructions to:
detect a line of sight of a user based on an image obtained by capturing the user who intends to ride in a vehicle including a plurality of doors;
determine, based on the detected line of sight, whether or not the user has looked at a region corresponding to a specific door for a predetermined time or more;
authenticate the user using the image; and
unlock the specific door in a case where it is determined that the user has looked at the region corresponding to the specific door for the predetermined time or more and the user has succeeded in the authentication.

2. The vehicle door control apparatus according to claim 1, wherein the at least one processor is configured to execute the instructions to change the predetermined time in accordance with a direction of a face of the user in the image.

3. The vehicle door control apparatus according to claim 1, wherein the at least one processor is configured to execute the instructions to change the predetermined time in accordance with a distance between the user and the vehicle.

4. The vehicle door control apparatus according to claim 1, wherein the at least one processor is configured to execute the instructions to:
determine whether or not the user has looked at the region corresponding to the specific door for the predetermined time or more after a distance between the user and the vehicle is within a first distance, and
unlock the specific door after the distance between the user and the vehicle is within a second distance shorter than the first distance.

5. The vehicle door control apparatus according to claim 1, wherein the at least one processor is configured to execute the instructions to authenticate the user by face authentication.

6. The vehicle door control apparatus according to claim 5, wherein the at least one processor is configured to execute the instructions to:
determine whether or not a face of the user in the image is a face of a living body based on the image while the user is moving toward the vehicle, and
fail to authenticate the user in a case where the face of the user in the image is not determined to be the face of the living body.

7. The vehicle door control apparatus according to claim 6, wherein the at least one processor is configured to execute the instructions to determine whether or not the detected line of sight has changed with a change in a distance between the user and the vehicle, and based on a result of the determination, determines whether or not the face of the user in the image is the face of the living body.

8. The vehicle door control apparatus according to claim 6, wherein the at least one processor is configured to execute the instructions to determine whether or not the face of the user in the image is the face of the living body based on a movement of a torso of the user in the image and a movement of the face in the image.

9. The vehicle door control apparatus according to claim 8, wherein the at least one processor is configured to execute the instructions to determine whether or not a vertical movement of a region of the face of the user in the image is interlocked with a vertical movement of a region of the torso of the user in the image, and based on a result of the determination, determines whether or not the face of the user in the image is the face of the living body.

10. A vehicle door control method comprising:
detecting a line of sight of a user based on an image obtained by capturing the user who intends to ride in a vehicle including a plurality of doors;
determining, based on the detected line of sight, whether or not the user has looked at a region corresponding to a specific door for a predetermined time or more;
authenticating the user using the image; and
unlocking the specific door in a case where it is determined that the user has looked at the region corresponding to the specific door for the predetermined time or more and the user has succeeded in the authentication.

11. A non-transitory computer-readable medium storing a program for causing a processor to execute processing comprising:
detecting a line of sight of a user based on an image obtained by capturing the user who intends to ride in a vehicle including a plurality of doors;
determining, based on the detected line of sight, whether or not the user has looked at a region corresponding to a specific door for a predetermined time or more;
authenticating the user using the image; and
unlocking the specific door in a case where it is determined that the user has looked at the region corresponding to the specific door for the predetermined time or more and the user has succeeded in the authentication.
